(19) United States
(12) Patent Application Publication
(10) Pub. No.: US 2003/0136831 A1
(43) Pub. Date: Jul. 24, 2003

(54) Method and apparatus for guiding shoppers in a store in a time efficient manner

(76) Inventor: Ray Alford, Granite Bay, CA (US)

Correspondence Address: Ray Alford Jr., 6700 Auburn Folsom Road, Granite Bay, CA, 95746-7334, US

(21) Appl. No.: 10/053,802

(22) Filed: Jan. 24, 2002

(51) Int. Cl. G06K 15/00

(52) U.S. Cl. 235/383

(57) ABSTRACT

The method and apparatus of the present invention provide a tablet containing a plurality of pages wherein each page has a map of the store presented to the shopper. The map is organized such that a graphical image of the various areas of the store are shown as they relate to a known point in the store, for example, the entrance. Moreover, each graphical image representing a particular area of the store contains a list of products found in that area. Interspersed within each graphical image are guidelines for entering shopper notes on what items to collect when in that particular area of the store. Other main features of the store are also shown, including the check-out area, restrooms, and customer service area, to name only a few.

The subject of this invention relates generally to commercial shopping. Specifically, this invention describes a method and apparatus for guiding shoppers through a store in a way that allows the shopper to navigate with respect to known features of the store. The method orients the shopper to enable efficient location of products thereby saving time.

### BACKGROUND OF THE INVENTION

Historically, shopping has been a relatively localized activity. As late as the middle of the twentieth century, most stores were of one of two types: a neighborhood, or so-called “mom and pop” store, or a large department store. Both of these stores were easy to navigate. The mom-and-pop store was small, usually containing only several aisles of products. The large department stores, while containing many more products, usually were well defined by floor or department. In either case the task of locating a particular item was, generally, easy.

Further, the mom-and-pop store had the advantage of being close to the shopper. Since the store was in the neighborhood, a shopper could walk or drive a short distance. While the department type stores were farther away, thus not as easy to get to as the mom-and-pop store, the number and diversity of products carried by the store made the trip worthwhile. In both cases, the need for efficient planning for a shopping trip was not as great as it is today.

Within the past several decades the need to plan a shopping trip in order to maximize time efficiency has emerged due to a number of developments. Among these are urban sprawl, the introduction of the so called ‘big box’ stores, the trend to specialize in a product genre, and increased pressure to reduce environmental impacts of local travel. Urban sprawl has greatly increased the distance to drive with an attendant increase in the time needed to complete a shopping trip. Add to this the increased number of hours that vehicles are operating, the impact on the environment due to emissions also has increased.

The introduction of the big-box stores has also decreased the efficiency of shopping trips. But in this case the decrease, while compounded by distance, is sourced more in the sheer size of the commercial establishment. And while many of these warehouse stores provide a centrally located store layout, or alternatively provide aisle markers, some do not. The task of locating a specific product thus is reduced to moving up and down the aisles until the desired product is located. Coupled to the size of these commercial establishments, the nature of specialization of the stores further decreases shopping efficiency. In an earlier time, a shopper could go to a department store and find hardware, furniture, and clothes. Today that ability has all but disappeared.

Shoppers, faced with large areas, greater choice, less ability to quickly, efficiently locate a specific product are finding that a shopping trip requires planning in order to eliminate multiple trips and wasted time. Moreover, the need to find restrooms, or other facilities such as customer service has been hampered by the sheer size.

One current method for assisting shoppers in these large commercial establishments is a product locator map at the entrance or located randomly throughout the store. The disadvantage of this method is the need to return to the map to regain orientation. This can be a significant problem if a shopper has a loaded cart or basket that must be pushed or carried to the location of the map. For example, consider a shopper with a push cart of wall studs or fencing. To find the nails or concrete the entire load must be pushed to the locator map.

Also known in the art are signs at the head of the various aisles, but as with the above map methods, the shopper must return to the head of the aisle to view the product scope contained in that aisle. Even then the shopper does not get a detailed notion of what or where a specific product is located in the aisle.

Still a third method currently known to those of skill in the art are electronic stations located randomly throughout the store. Unfortunately these devices, as well as having the disadvantages described above, suffer from an additional disadvantage for a large population of shoppers, since these devices require some knowledge of how to approach and use a video terminal device.

As can be seen, the existing methods for guiding a shopper in a commercial establishment in an efficient manner suffer from one or more disadvantages. What would be desirable would be a method that would guide a shopper in a commercial establishment in a time efficient manner. It would be further desirable that the method be portable, so that the shopper need not return to a specific location to reorient themselves. Still another desirable feature would be a method whereby the shopper could identify products with great specificity.

### SUMMARY OF THE INVENTION

The method and apparatus of the present invention provide a tablet containing a plurality of pages wherein each page has a map of the store presented to the shopper. The map is organized such that a graphical image of the various areas of the store are shown as they relate to a known point in the store, for example, the entrance. Moreover, each graphical image representing a particular area of the store contains a list of products found in that area. Interspersed within each graphical image are guidelines for entering shopper notes on what items to collect when in that particular area of the store. Other main features of the store are also shown, including the check-out area, restrooms, and customer service area, to name only a few.

In an alternative embodiment of the present invention, the reverse surface of each tablet page contains information and or data related to the type of commercial establishment. For example, if the commercial establishment is one of the “home improvement” genre, the reverse surface of each page might contain a table of conversions for liner measurements and a standard grid to make scaled sketches. Similarly, if the commercial establishment is a grocery store, the reverse side might contain in-store coupons.

In use, the method of the present invention allows the shopper to enter the store, obtain a tablet, for example, from the area where shopping carts or baskets are stored, mark what products to collect in the various areas of the store, then proceed to those items in a time efficient manner. This occurs since the shopper is provided with physical references on the tablet. For example, the entrance may be the reference. Alternatively, the checkout counters or customer service could serve as the physical reference. As will be recognized by those of skill in the art, the exact reference may vary without departing from the spirit of the invention, thus the scope of the invention is limited only by the claims.

Advantageously, the apparatus of the present invention is portable and may be removed from the store with the shopper. Thus for future shopping trips the shopper may pre-annotate the apparatus of the present invention gaining an additional time efficiency improvement. The operator of the store gains the advantage of increasing repeat shopper visits since the store, and thus its contents, are well known to the shopper. These and other advantages of the present invention are discussed in detail below in conjunction with the drawings and figures attached.

### BRIEF DESCRIPTION OF THE DRAWINGS

FIG. 1 illustrates the apparatus used in a first embodiment of the method of the present invention.

FIG. 2 presents a single page of a tablet of the apparatus used in a first embodiment of the method of the present invention.

FIG. 3 presents the detail of a single entry on a page of a tablet of the apparatus used in a first embodiment of the method of the present invention.

### DETAILED DESCRIPTION OF PREFERRED EMBODIMENTS

As described briefly above, there are a number of disadvantages with the current methods for assisting shopper navigation through a store. Each of these disadvantages may be overcome using the method and apparatus of the present invention.

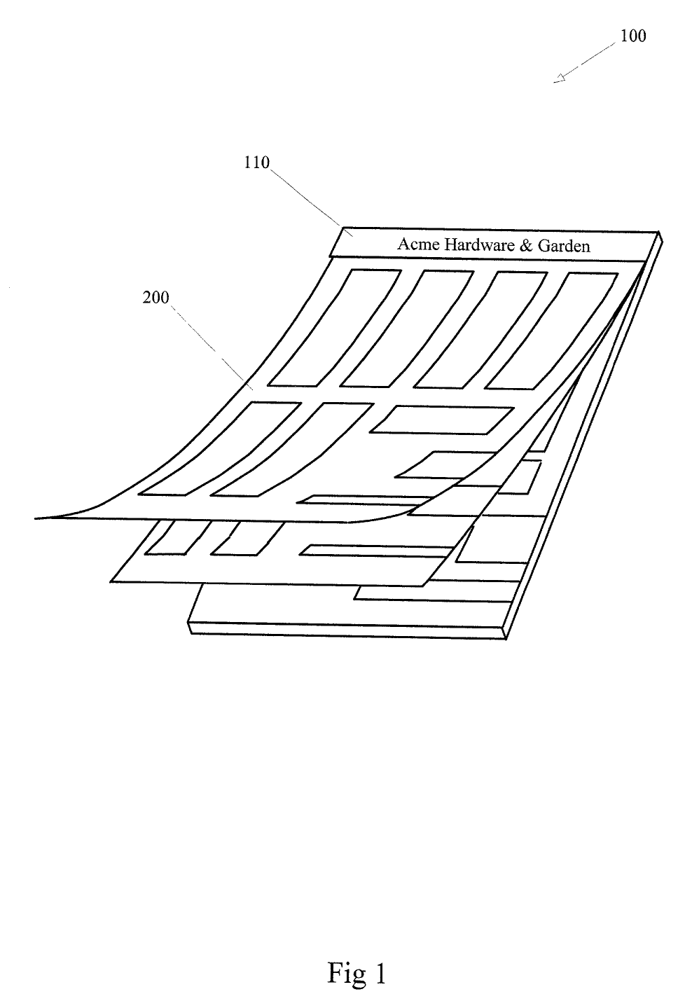

Referring to FIG. 1, the apparatus 100 of the present invention is shown. The apparatus of the present invention consists of a plurality of pages 200 forming a tablet 110, each of the pages 200 having a front and back surface. The front surface of each of the pages 200 displays a graphical image of the store. As will be discussed in detail below, a physical reference point, for example, the entrance to the store, is provided such that the shopper can navigate the entire store simply by referring to the image on the tablet page.

Note that in for the apparatus of FIG. 1, the front surface of the exemplary page 200 contains only a graphical image of the store, but this should not be read as a limitation on the scope of the invention. Other information, including but not limited to, banner advertisements, coupons, or special offers could also be present without departing from the spirit of invention, thus the scope of the present invention is limited only by the claims.

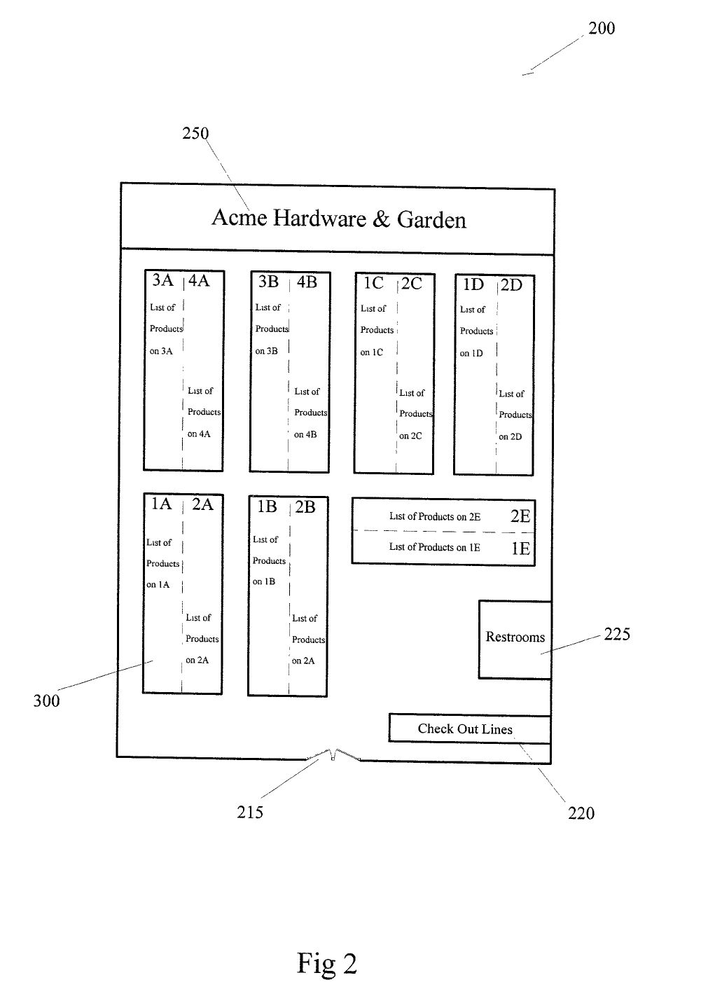

Referring now to FIG. 2, a single page 200 of the tablet 110 is shown in greater detail. As can be seen, the spine 250 of the tablet 110 may be used for banner advertisements, or the like, in this case the name of the store. As described above, this banner advertisement is exemplary in nature and should not be read as a limitation on the scope of the present invention.

The detailed page 200 of the tablet 110 shows the layout of the store including a number of physical references that may be used to assist the shopper in navigating efficiently to a specific area of the store. For example, the entrance 215, the checkout counters 220 and the restrooms 225 are also shown. Thus if the shopper were located in the rear of the store looking for a specific product and had the need to use the restrooms 225, a simple glance at the page 200 would provide information on how to navigate to the restrooms 225. In a similar manner, any area of the store may be located and an efficient path to that location shown by glancing at the page 200.

In an alternative embodiment of the present invention, the front surface of the page 200 of the tablet 110 is not the only surface used to assist the shopper. The reverse surface (not shown) may also be used to present information or advertisement to the shopper. For example, if the store is a “home improvement” type, the reverse surface of the page 200 might contain a uniform grid for making sketches of a construction project useful in determining quantities and dimensions of material required. As will be recognized by those of skill in the art, a variety of information or advertisement may be placed on the reverse surface without departing from the spirit of the invention, thus the description above is exemplary only and should not be read as a limitation on the scope of the invention.

Also shown in FIG. 2 is an exemplary product locator 300 for aisle 1A. As can be seen, each of the other aisles in the store similarly contain lists of products that can be found in that particular aisle. It will be obvious to those of skill in the art the lists of products may be more or less detailed as space on the page 200 permits, thus the presence or absence of specific details in the exemplary aisle 300 should not be read as a limitation on the scope of the present invention.

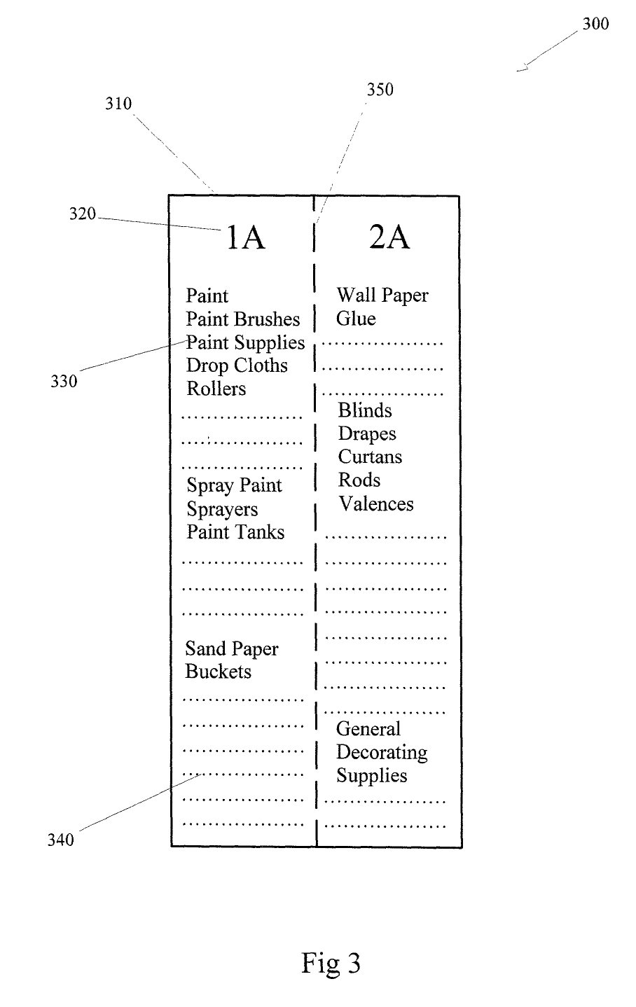

Looking now at FIG. 3, the exemplary aisle 300 is shown in detail. For this example, an aisle containing painting supplies has been shown, but, as will be obvious to those of skill in the art, other specific products could be listed without departing from the spirit of the present invention.

Aisle 300 is composed of two sections, 1A 310 and 2A (not referenced), separated by divider 350. Focusing on aisle 1A 310, a highly granular level of product detail is shown, for example, products 330. Interspersed between the detailed list of products are guidelines 340 for use by the shopper in making notes. This ability to annotate the list with additional detail or quantity information aids in increasing the efficiency of the shoppers experience. Thus by providing the shopper with a highly detailed, portable, annotatable store reference, the shoppers in-store experience is improved by greatly increasing the time efficiency of the shopping trip.

A first advantage of the present invention is that it provides a visual reference for the shopper that allows direct navigation to a desired product or product category. A simple glance at the product locator provides the information needed to navigate efficiently within the store.

A second advantage of the present invention is that it is portable. This eliminates the need to return to a point for reference. For example, to the head of an aisle or to a main map.

A third advantage of the present invention is that it provides rapid access to store facilities such as restrooms and customer service. Further, locations of emergency exits and first aid stations may be prominently indicated, providing an increased level of safety to the shopper.

Still a fourth advantage of the present invention is that the shopper has the ability to remove the tablet form the store and, in future, prepare a detailed shopping list prior to arriving at the store, again increasing the efficiency of the shopping experience. While shopping lists are by no means novel, the level of detail provided by the method of the present invention coupled to a precise location of the specific product within the store is an advancement in the art.

Yet a fifth advantage of the present invention is that the store operator has placed advertising directly in the hands of the end customer. Thus when the shopper has a need for a product supplied by the operator of the store, and since the shopper already knows the location of the store and its general layout, that shopper is likely to return to the store rather than choose an alternative shopping establishment.

In an alternative embodiment of the present invention, yet a sixth advantage is the presence of data related to the type of commercial establishment, further enabling the shopper to improve the efficiency of the shopping experience. Such diverse information as savings coupons, conversion data, or in-store specials are readily accessible to the shopper.

What is claimed is:

1. A method for improving shopper navigation in a store by assisting in locating specific areas of said store in a time efficient manner, comprising:
providing a hand carried apparatus imprinted with a graphical image of the layout of the store, said graphical image further providing detailed information related to the location of specific products within said store, and;
providing in at least one area of said graphical image a physical reference point within said store such that said graphical image may be used by a shopper to determine where one of said specific products is located.

2. The graphical image of claim 1 further providing the location of a plurality of facilities within the store including, but not limited to, safety facilities, restrooms, customer service counter and checkout area.

3. The graphical image of claim 1 wherein an area is provided for annotating said graphical image with shopper entered data, said area being comprised of guidelines.

4. An apparatus for improving shopper navigation in a store by assisting in locating specific areas of said store in a time efficient manner, comprising:
a plurality of pages, each page having four edges, a front surface and a rear surface, said pages joined at one of said edges to form a portable tablet;
the front surface of said pages having imprinted upon it a graphical image representing the layout of a store;
said graphical image further comprising at least one physical reference point, such that a shopper in said store is able to determine a specific location within said store and navigate to said specific location in a minimum of time.

5. The apparatus of claim 4 wherein the reverse surface of the pages is further comprised of an imprinted image, said imprinted image being one or more of data, advertisement or information.

6. The front surface of the page of claim 4 further comprising an area for shopper annotation, said area being comprised of a plurality of guidelines.
